(19) United States
(12) Patent Application Publication
(10) Pub. No.: US 2014/0364179 A1
(43) Pub. Date: Dec. 11, 2014

(54) Combine harvester

(71) Applicant: Claas Selbstfahrende Erntemaschinen GMBH, Harsewinkel (DE)

(72) Inventors: Joern Brinkmann, Harsewinkel (DE); Christian Beulke, Harsewinkel (DE); Martin Niermann, Harsewinkel (DE)

(73) Assignee: CLAAS SELBSTFAHRENDE ERNTEMASCHINEN GMBH, Harsewinkel (DE)

(21) Appl. No.: 14/272,947

(22) Filed: May 8, 2014

(30) Foreign Application Priority Data
Jun. 6, 2013 (DE) 10 2013 105 836.1

(51) Int. Cl. A01F 29/12

(52) U.S. Cl. CPC A01F 29/12
USPC 460/112

(57) ABSTRACT

A combine harvester includes a first discharge mechanism having a changeable discharge direction, a chopping assembly for chopping up straw and a second discharge mechanism disposed downstream of the chopping assembly. The second discharge mechanism disposed is operated at least two different positions. In a first position, the second discharge mechanism is supplied with crop from the chopping assembly and the first discharge mechanism. In a second position, the second discharge mechanism disposed permits crop to be discharged upon bypassing the second discharge mechanism. The discharge direction of the first discharge mechanism is dependent upon the operating state of the chopping assembly.

### CROSS-REFERENCE TO A RELATED APPLICATION

The invention described and claimed hereinbelow is also described in German Priority Document DE 10 2013 105836.1, filed on Jun. 6, 2013. The German Priority Document, the subject matter of which is incorporated herein by reference, provides the basis for a claim of priority of invention under 35 U.S.C. 119(a)-(d).

### BACKGROUND OF THE INVENTION

The present invention relates to a combine harvester with first discharge mechanism having a changeable discharge direction, a chopping assembly for chopping up straw and a second discharge mechanism disposed downstream of the chopping assembly that can be operated in at least two different positions such that in the first position, the second discharge mechanism is supplied with crop from the chopping assembly and the first discharge mechanism and in the second position, second discharge mechanism permits crop to be discharged upon bypassing the second discharge mechanism.

A related combine harvester is known from EP 1 328 145 A1 to comprise a chopping assembly, wherein a discharge mechanism designed as a radial spreader is used to discharge chopped straw onto the ground. The discharge mechanism is disposed downstream of this chopping assembly. The combine harvester furthermore comprises a chaff spreading mechanism, to which chaff is fed from a cleaning mechanism of the combine harvester. The discharge direction of the chaff spreading mechanism can be changed to be adapted to different operating situations of the combine harvester, i.e., chopping straw or depositing swath. The chaff spreading mechanism comprises two chaff spreaders, the discharge direction of which is positioned such that the two chaff spreaders bundle the chaff into one crop stream and transfer this directly to the radial spreaders. The radial spreaders discharge the chaff together with the chopped straw.

In the case of depositing swath, the chaff spreaders are positioned such that the chaff is discharged by the chaff spreaders laterally relative to the combine harvester and at a distance from the swath. The combine harvester according to EP 1 328 145 A1 permits diverse operating variants of chaff spreaders and radial spreaders. The operator of the combine harvester is responsible for selecting one of the operating variants. Document EP 1 328 145 A1 does not suggest, however, how changing the operating situation of the combine harvester (i.e., switching from the chopping operation to the swath-depositing operation and vice versa), affects the chopping assembly as well as the radial spreader and the chaff spreaders.

### SUMMARY OF THE INVENTION

The present invention overcomes the shortcomings of known arts, such as those mentioned above.

To that end, the present invention provides a combine harvester that can be operated more efficiently.

In one embodiment, the invention provides a combine harvester with first discharge mechanism having a changeable discharge direction, a chopping assembly for chopping up straw and a second discharge mechanism disposed downstream of the chopping assembly that can be operated in at least two different positions such that in the first position, the second discharge mechanism is supplied with crop from the chopping assembly and the first discharge mechanism and in the second position, second discharge mechanism permits crop to be discharged upon bypassing the second discharge mechanism.

The discharge direction of the first discharge device is dependent on the operating state of the chopping assembly. The advantage to such an arrangement is that the discharge direction of the first discharge assembly is automatically changed when the operating state is changed, i.e., when the chopping assembly is engaged or disengaged. An operator of the combine harvester is thereby relieved of the need to pay attention to whether the second discharge mechanism, in the second position thereof, is unintentionally supplied with crop by the first discharge mechanism, wherein the second discharge mechanism, due to the positioning thereof, cannot receive and process the crop.

Preferably, the chopping assembly is decoupled from a drive in the second position of the second discharge mechanism. As a result, the energy demand by the combine harvester is reduced when the second discharge device is in the second position thereof, i.e., when the chopping assembly and the second discharge mechanism of the combine harvester are set for depositing swath.

The second discharge device, in the second position thereof, also can be decoupled from a drive train. This measure therefore also contributes to increased energy efficiency.

Advantageously, in the first position of the second discharge mechanism, the discharge direction of the first discharge mechanism can point in the direction of the second discharge mechanism, while, in the second position of the second discharge mechanism, the first discharge mechanism has a laterally outwardly oriented discharge direction. When the discharge direction of the first discharge mechanism points in the direction of the second discharge mechanism, the first discharge mechanism feeds a bundled crop stream to the second discharge mechanism. If the discharge direction of the first discharge mechanism is oriented laterally outwardly, crop is discharged on both sides of the combine harvester.

In particular, the discharge direction of the first discharge mechanism is changed by use of hydraulic cylinders. The use of hydraulic cylinders as actuating means for changing the discharge direction of the discharge mechanism permits easy integration into the hydraulic circuit, which is usually present on a combine harvester.

The hydraulic cylinders are controlled by a hydraulic valve dedicated to the chopping assembly. The hydraulic valve controls the activation and deactivation of the hydraulically driven chopping assembly and the discharge direction of the first discharge mechanism.

In order to control the hydraulic cylinders of the first discharge mechanism, these hydraulic cylinders are permanently subjected to a constant pressure on the rod end, while the hydraulic cylinders are subjected to a higher pressure on the face end by switching the hydraulic valve. By closing the hydraulic valve, the pressure on the rod end of the hydraulic cylinders is made greater than the pressure on the face end, whereupon the hydraulic cylinders are retracted into the rods. When the hydraulic cylinders are retracted, the discharge direction of the first discharge mechanism becomes oriented laterally outwardly, substantially transversely to the direction of travel of the harvesting machine. When the hydraulic valve is opened, i.e., when the chopping assembly is started up, the pressure is greater on the face end and, therefore the hydraulic cylinders are extended out of the rods. When the hydraulic cylinders are extended, the discharge direction of the first discharge mechanism is transferred into the direction of the second discharge mechanism.

As an alternative, the first discharge mechanism and the second discharge mechanism are mechanically coupled to one another and, therefore, when the second discharge mechanism is transferred from the first position into the second position, and vice versa, the discharge direction of the first discharge mechanism changes. To this end, the first and the second discharge mechanisms are connected to one another by a lever arrangement. Using the lever arrangement, the discharge direction of the first discharge mechanism is changed in the event of a transfer of the second discharge mechanism from the first position thereof into the second position, or vice versa.

In a development, the second discharge mechanism is designed as a pair of radial spreaders.

In another development, the first discharge mechanism is designed as a pair of oppositely rotating chaff spreaders and, preferably is supplied with crop by a cleaning mechanism of the combine harvester.

### BRIEF DESCRIPTION OF THE DRAWINGS

Further features and advantages of the invention will become apparent from the description of exemplary embodiments that follows, with reference to the attached figures, wherein:

FIG. 1 presents a schematic side view of a combine harvester, configured according to the invention;

FIG. 2 presents a schematic side view of a rear region of the combine harvester of FIG. 1, with a partially exposed view of a chopping assembly and a second discharge mechanism depicted in the chopping mode;

FIG. 3 presents a view of a first discharge mechanism of the FIG. 2 embodiment seen diagonally from below;

FIG. 4 presents a schematic side view of a rear region of the harvesting machine of FIG. 1 in the swath-depositing mode;

FIG. 5 presents a view of the first discharge mechanism of FIG. 4 embodiment seen diagonally from below; and

FIG. 6 presents a schematic depiction of a hydraulic system for controlling the first discharge mechanism.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

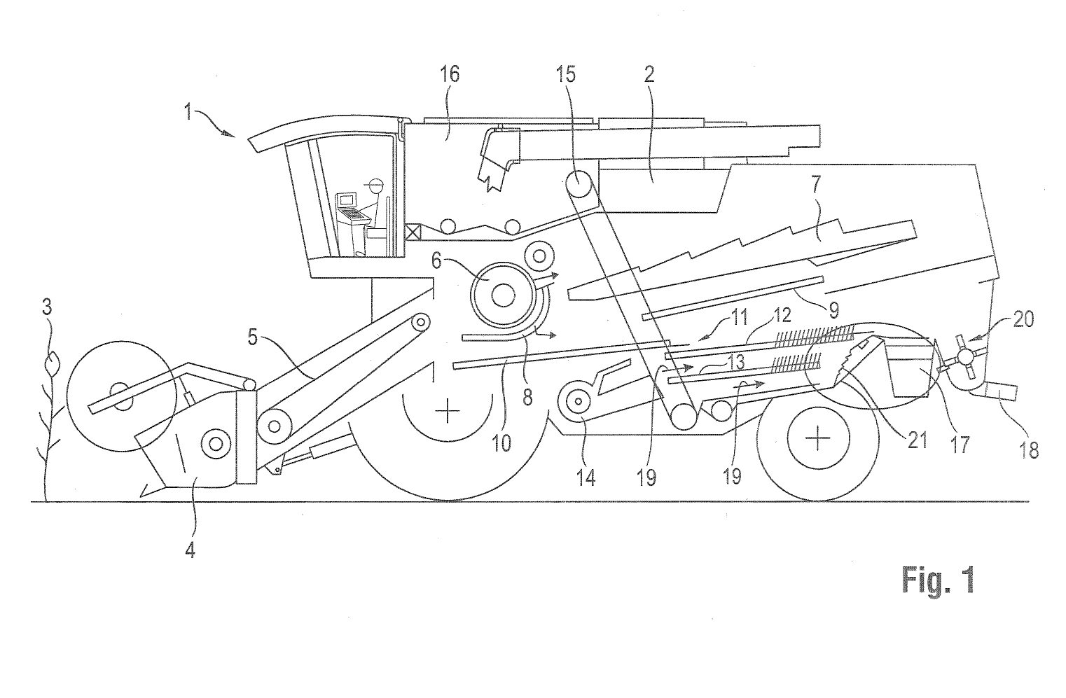

FIG. 1 depicts a self-propelled agricultural harvesting machine 1 used to pick up and process crop 3. The self-propelled agricultural harvesting machine 1 is a combine harvester 2 equipped with a header 4. With the aid of a feed rake 5, header 4 feeds the crop 3 to a threshing mechanism. The threshing mechanism comprises a cylinder 6 and a concave 8 and is abutted by a separating mechanism designed as a tray-type shaker 7. A return pan 9 and a return device 10, which direct the separated-out crop 3 to a cleaning mechanism 11 comprising an upper sieve 12 and a lower sieve 13, are disposed underneath the concave 8 and the tray-type shaker 7. The upper sieve 12 and the lower sieve 13 are acted upon by an air stream 19, which is produced by a cleaning fan 14 and flows through and over the sieves 12, 13. The cleaned crop 3 is conveyed by a grain elevator 15 into a grain tank 16, where it is collected. A crop portion such as straw, for example, that is conveyed by the tray-type shaker 7, is fed across the rear part of the combine harvester to a chopping assembly 20.

The crop portions, such as chaff, that are transported to the rear end of the combine harvester 2 by way of the upper sieve 12 and the lower sieve 13 by the movement thereof and, by the air stream 19, are fed to a first discharge mechanism 17. The first discharge mechanism 17, as shown, is designed as a chaff blower. The crop that is chopped up by the chopping assembly 20 is fed by this chopping assembly to a second discharge mechanism 18. The second discharge mechanism 18 is designed as a radial spreader, which spreads the crop portions on the ground across the width of the header 4.

The crop delivered by the first discharge mechanism 17 and the cleaning mechanism 11 can be fed, together with the crop arriving from the chopping assembly 20, to the second discharge mechanism 18 in order to be spread on the field. The first discharge mechanism 17 and the second discharge mechanism 18 are each embodied as a pair, wherein each pair is arranged as a side-by-side mirror image. The structural designs of the respective pairs are identical, and therefore only one of the discharge mechanisms 17, 18, which are arranged as pairs, will be described in the following. Since the depiction is a side view, only one of the first and the second discharge mechanisms 17, 18 is visible in each case.

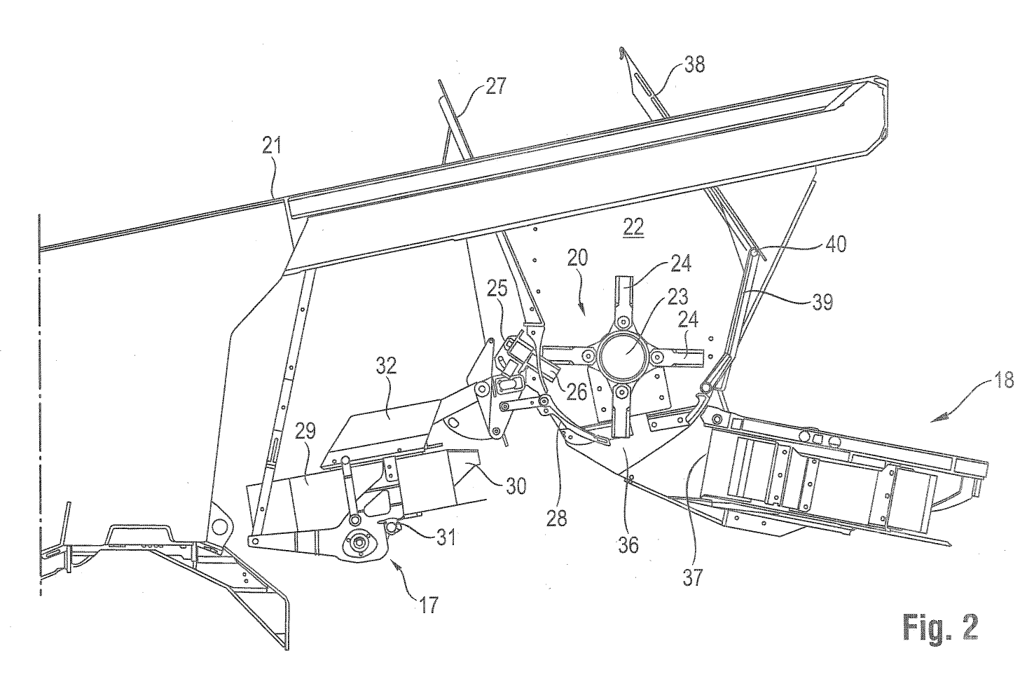

As an alternative, the combine harvester 2 is operated to deposit the threshed-out straw on the field as swath. In this case, the straw delivered by the tray-type shaker 7 is deposited on the field, bypassing the chopping assembly 20 and the second discharge mechanism 18. The second discharge mechanism 18 assumes different positions depending on the operating mode of the combine harvester 2, i.e., the chopping mode or the swath-depositing mode. The different positions of the second discharge mechanism 18 will be described reference to FIGS. 2 to 6. The straw that has been deposited on the field as swath can be subsequently picked up by a baler.

The depiction in FIG. 2 is a schematic side view of the rear region of the harvesting machine according to FIG. 1, in the chopping mode, with a partially exposed view of the chopping assembly 20 and the second discharge mechanism 18. The view in FIG. 2 shows a frame 21 of the combine harvester 2, on which various components of the combine harvester 2 are mounted. The straw chopper 20 comprises two side panels 22, which are disposed parallel to one another. Between panels 22, a cutting cylinder 23 equipped with free-swinging knives 24 is disposed in a rotatably driveable manner. A knife carrier 25 with counter-blades mounted thereon is disposed coaxially to the cutting cylinder 23. A chopper guide plate 27 is disposed above the cutting cylinder 23, by which the crop delivered by the separating mechanism or tray-type shaker 7, which is substantially threshed-out straw, is fed to the chopping assembly 20. The chopped crop is redirected via a bottom plate 28, through a crop outlet opening 36, in the direction of a crop inlet opening 37 of the second discharge mechanism 18.

FIG. 2 also shows an upper flap 38 positioned opposite the chopper guide plate 27, and a lower flap 39 swivellably connected to this upper flap in an articulated manner about a rotational axis 40. The upper flap and lower flap are used to redirect the crop delivered by the separating mechanism 7 past the chopping assembly 20 during operation of the combine harvester 2 in the swath-depositing mode.

The first discharge device 17 is disposed downstream of the cleaning mechanism 11 and receives the crop delivered by the cleaning mechanism 11 in order to forward this crop directly to the second discharge mechanism 18 or discharge this crop onto the field laterally relative to the combine harvester 2, depending on the operating mode of the combine harvester 2. The discharge direction of the first discharge mechanism 17 is adjusted depending on the operating mode of the combine harvester 2. To this end, the first discharge mechanism 17 comprises a housing 29, which has a non-illustrated rotor in the interior thereof. A limiting element 32 embodied as a rubber blanket is disposed on the top side of the first discharge device 17 and prevents the crop from being conveyed by the cleaning mechanism 11 beyond the first discharge mechanism 17.

The limiting element 32 ensures that the crop does not become deposited onto the rotors of the first discharge mechanism 17. A hydraulic cylinder 31 is used to change the discharge direction of the first discharge mechanism 17. The hydraulic cylinder 31 is located on the underside of the discharge mechanism 17. The housing 29 has a discharge opening 30, which faces the chopping assembly 18 in the operating mode of the combine harvester shown, which is the chopping mode.

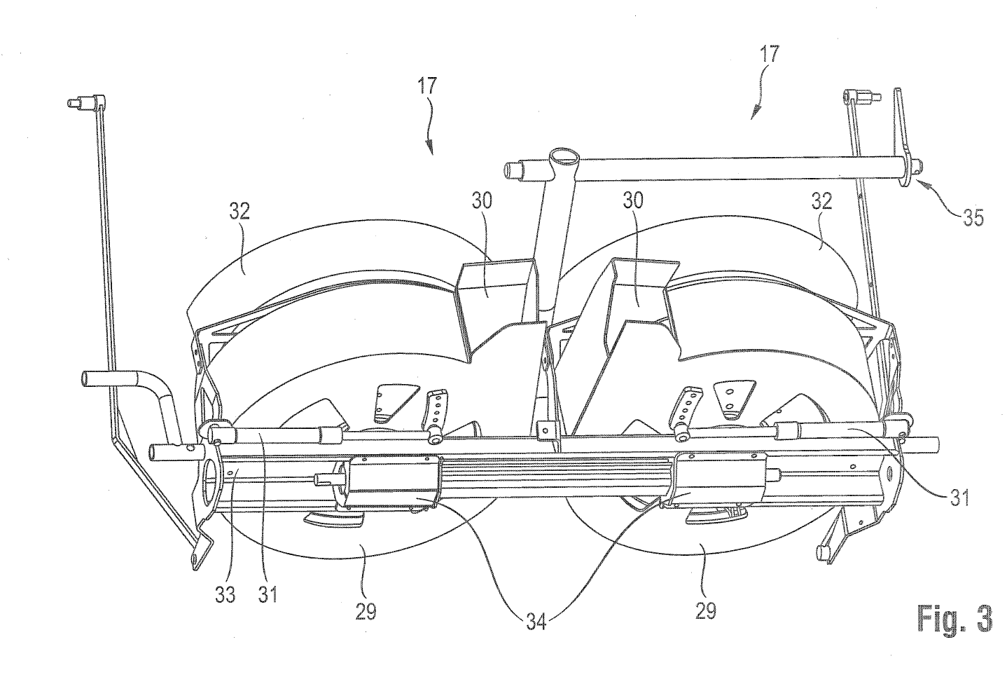

FIG. 3 shows a view of the first discharge mechanism 17 as seen diagonally from below. This depiction clearly shows the mirror-image arrangement of the first discharge mechanism 17, which is embodied as a pair. A frame element 33, which carries the preferably hydraulic drive 34 of the first discharge mechanism 17, is disposed on the underside of the housing 29. The connecting rods of the hydraulic cylinders 31 are in the extended position. The discharge mechanisms 17 are connected to the frame 21 via a suspension 35.

The second discharge mechanism 17 is disposed downstream of the chopping assembly 20, as viewed in the direction of conveyance of the crop stream. In the operating mode of the combine harvester 2 depicted in FIG. 2, the second discharge mechanism 18 is acted upon with crop from the chopping assembly 20 and from the first discharge mechanism 17. The crop delivered by the chopping assembly 20 is transferred to the respective downstream second discharge mechanism 18 substantially without a change in direction. The crop outlet opening of the chopping assembly 20 and the crop inlet direction of the respective second discharge device 18 are located in the same plane. The crop delivered through the discharge opening 31 of the respective first discharge mechanism 17 passes through the crop inlet opening 37 and enters the second discharge mechanism 18.

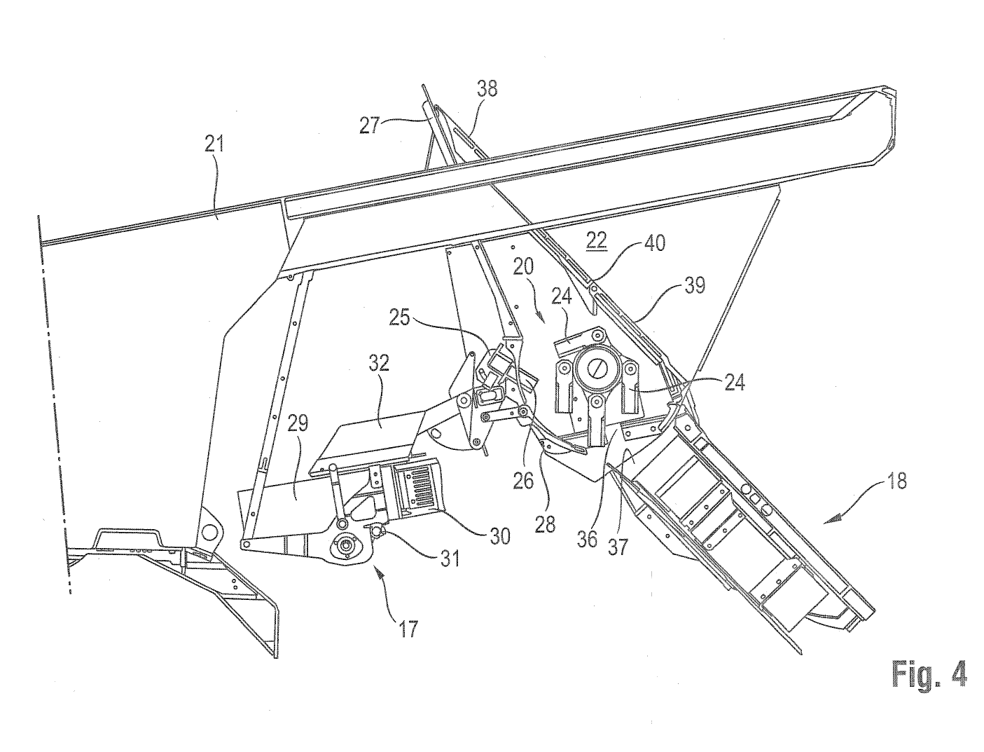

FIG. 4 presents a side view of the rear region of the harvesting machine 1 according to FIG. 1, in the swath-depositing mode. This depiction differs from that shown in FIG. 2 in that the second discharge mechanism 18 has been moved into a position in which the crop to be discharged is deposited onto the ground behind the combine harvester 2 in the form of a swath after bypassing the chopping assembly 20 and the second discharge mechanism 18. The lower flap 39, which is described above by reference to FIG. 2, is moved into a position relative to the upper flap 38 in which these flaps are substantially in alignment with one another.

In addition, the second discharge mechanism 18 is disposed at the side panels 22 in a manner swivellable about an axis, and therefore the surface of the second discharge mechanism 18 extends virtually parallel to the upper and lower flaps 38, 39 and adjoins the lower flap 39. The result thereof is a continuous, slanted surface, on which the crop delivered by the separating mechanism 7 can bypass the chopping assembly 20 and be discharged onto the field. At the same time, the respective first discharge mechanism 17 is transferred into a position in which the discharge opening 30 of the respective discharge mechanism 17 has a laterally outwardly directed discharge direction. The crop, in particular chaff, which is delivered by the cleaning mechanism 11 to the respective second discharge mechanism 17, is discharged substantially transversely to the direction of travel of the combine harvester 2, on both sides thereof.

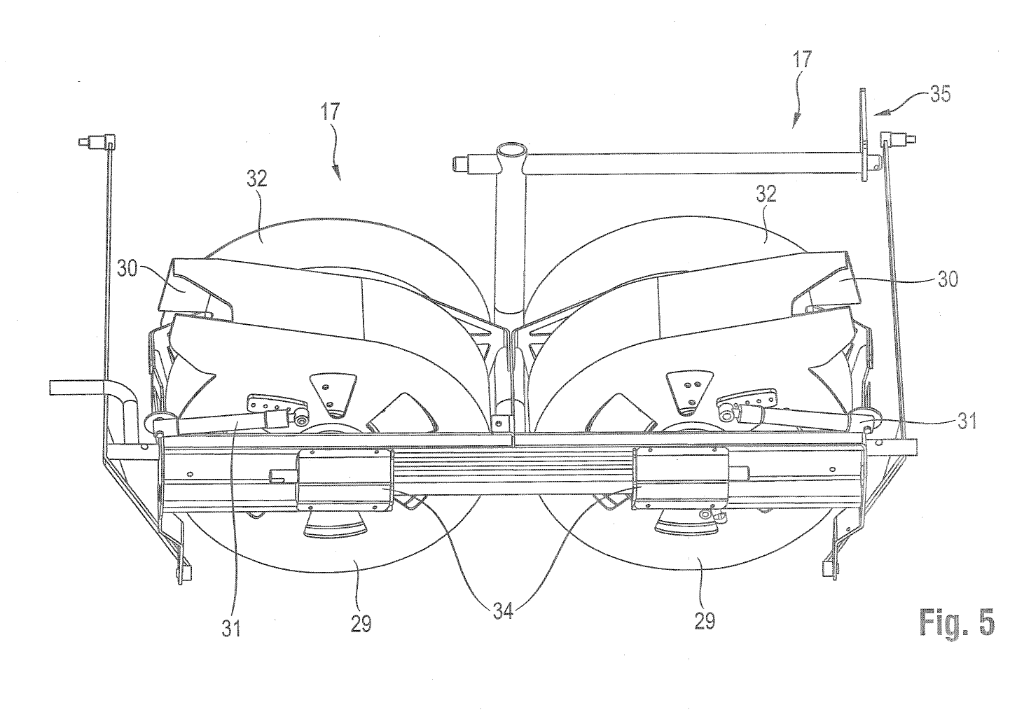

FIG. 5 depicts a view of the first discharge mechanism according to FIG. 4 as seen diagonally from below. As is clearly evident from this view, the discharge opening 30 of the respective discharge mechanism 17 faces laterally outwardly. The change in the discharge direction results from the retraction of the hydraulic cylinder 31, whereby the respective first discharge mechanism 17 is swivelled about the drive axis thereof. The hydraulic cylinder 31 is coupled to the hydraulic circuit of the chopping assembly 90 in order to ensure that the discharge direction of the first discharge mechanism 17 is changed only when switching from the chopping mode to the swath-depositing mode.

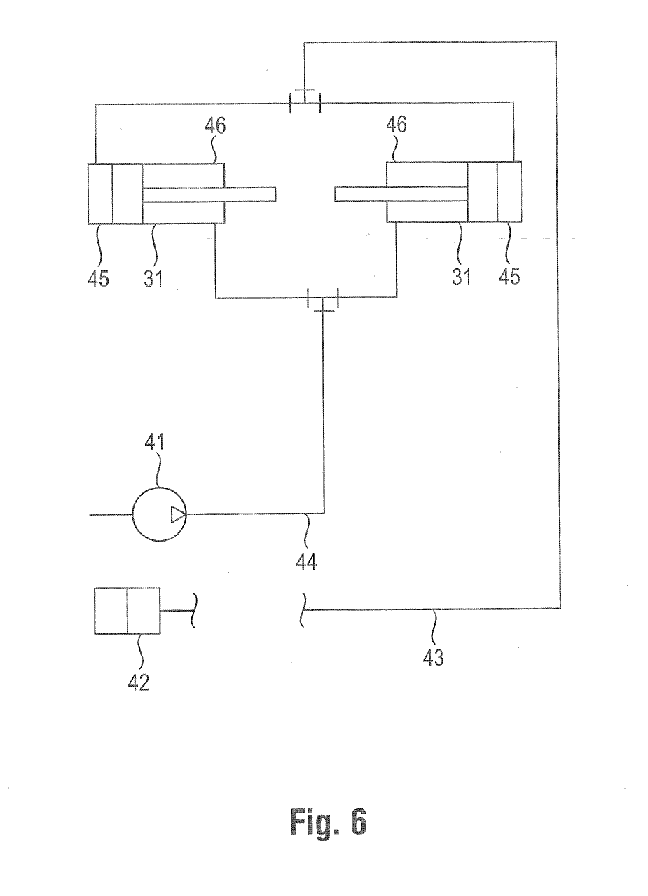

FIG. 6 shows a schematic depiction of a hydraulic system for controlling the first s discharge mechanism 17. The hydraulic system comprises a high-pressure circuit 43, which is switched by a hydraulic valve 42 and, a low-pressure circuit 44, which is permanently supplied by a pump 41. The permanent supply by pump 41 ensures that a constant pressure is maintained here. Hence as shown, the hydraulic cylinders 31 are permanently acted upon on the rod end 46 by a constant pressure from the low-pressure circuit 44. On the face end 45, the hydraulic cylinders 31 are acted upon by the high pressure from the high-pressure circuit 43, which is only present, however, when the hydraulically driven chopping assembly 20 is operating.

The action upon the face end 45 of the respective hydraulic cylinder 31 is controlled by the hydraulic valve 42 of the chopping assembly 20. In the chopping mode of the combine harvester 2, the hydraulic oil pressure required to drive the chopping assembly 20 is available and the hydraulic valve 42 is open. Correspondingly, a higher pressure is present at the face end 45 of the hydraulic cylinder 31 than on the rod end 46, and therefore the hydraulic cylinders 31 are extended. The respective discharge mechanism 17 therefore has a discharge direction that faces the respective crop inlet opening of the second discharge mechanism 18.

When the chopping assembly 20 is deactivated in the swath-depositing mode of the combine harvester 2, i.e., when the hydraulic valve 42 closes, there is no counter-pressure on the face end. Consequently, the hydraulic cylinders 31 are automatically retracted due to the pressure on the rod end, which is permanently present. As a result, the discharge direction of the first discharge mechanism 17 is forcibly changed. In order to reduce the energy consumption of the combine harvester 2 in the swath-depositing mode, the second drive mechanism 18 as well as the chopping assembly 20 are deactivated.

### List of Reference Characters

1 harvesting machine
2 combine harvester
3 crop
4 header
5 feed rake
6 cylinder
7 tray-type shaker
8 concave
9 return pan
10 return device
11 cleaning mechanism
12 upper sieve
13 lower sieve
14 cleaning fan
15 grain elevator
16 grain tank
17 first discharge mechanism
18 second discharge mechanism
19 air stream
20 chopping assembly
21 frame
22 side panel
23 cutting cylinder
24 free-swinging knives
25 knife carrier
26 counter-blade
27 chopper guide plate
28 ground
29 housing
30 discharge opening
31 hydraulic cylinder
32 limiting element
33 frame element
34 drive
35 suspension
36 crop outlet opening
37 crop inlet opening
38 upper flap
39 lower flap
40 rotational axis
41 pump
42 hydraulic valve
43 high-pressure circuit
44 low-pressure circuit
45 face end
46 rod end

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A combine harvester, comprising:
a first discharge mechanism having a changeable discharge direction;
a chopping assembly for chopping up straw; and
a second discharge mechanism disposed downstream of the chopping assembly;
wherein the second discharge mechanism operates in at least two different positions including a first position at which the second discharge mechanism is supplied with crop from the chopping assembly and the first discharge mechanism (17) and a second position that permits crop to be discharged upon bypassing the second discharge mechanism; and
wherein a discharge direction of the first discharge mechanism is dependent upon the operating state of the chopping assembly.

2. The combine harvester according to claim 1, wherein the discharge direction of the first discharge mechanism changes automatically depending on the operating state of the chopping assembly.

3. The combine harvester according to claim 1, wherein the chopping assembly is decoupled from a drive in the second position of the second discharge mechanism.

4. The combine harvester according to claim 1, wherein the second discharge mechanism in the second position thereof is decoupled from a drive.

5. The combine harvester according to claim 1, wherein the discharge direction of the first discharge mechanism in the first position of the second discharge mechanism points in a direction of the second discharge mechanism and wherein the first discharge mechanism in the second position of the second discharge mechanism assumes a laterally outwardly oriented discharge direction that faces away from the second discharge mechanism.

6. The combine harvester according to claim 1, wherein the discharge direction of the first discharge mechanism is changed by hydraulic cylinders.

7. The combine harvester according to claim 5, wherein the hydraulic cylinders are controlled by a hydraulic valve dedicated to the chopping assembly.

8. The combine harvester according to claim 6, wherein the hydraulic cylinders are permanently subjected to a constant pressure on a rod end and can be subjected to a higher pressure on the face end by switching the hydraulic valve.

9. The combine harvester according to claim, wherein the first discharge mechanism and the second discharge mechanism are mechanically coupled to one another and, when the second discharge mechanism is transferred from the first position into the second position, and vice versa, the discharge direction of the first discharge mechanism changes.

10. The combine harvester according to claim 8, wherein the first discharge mechanism and the second discharge mechanism are connected to one another by a lever arrangement.

11. The combine harvester according to claim 1, wherein the second discharge mechanism is designed as a radial spreader.

12. The combine harvester according to claim 1, wherein the first discharge mechanism is designed as a pair of oppositely rotating chaff spreaders.

13. The combine harvester according to claim 1, wherein the first discharge mechanism is supplied with crop from a cleaning mechanism of the combine harvester.
